(19) United States
(12) Patent Application Publication
(10) Pub. No.: US 2026/0265016 A1
(43) Pub. Date: Sep. 10, 2026

(54) RETRACTABLE DATA CABLE

(71) Applicant: DONGGUAN CEESING INTELLIGENT DEVICE MANUFACTURING CO.,LTD., Dongguan (CN)

(72) Inventors: Zhanxing LIN, Dongguan (CN); Shengwei ZHANG, Dongguan (CN); Guangbin LI, Dongguan (CN)

(73) Assignee: DONGGUAN CEESING INTELLIGENT DEVICE MANUFACTURING CO.,LTD., Dongguan (CN)

(21) Appl. No.: 19/661,525

(22) Filed: Apr. 28, 2026

Related U.S. Application Data
(63) Continuation-in-part of application No. 19/125,294, filed on Sep. 27, 2023.

(30) Foreign Application Priority Data
Sep. 29, 2022 (CN) 202222618475.X
Jul. 12, 2023 (CN) 202310859731.0
Jul. 12, 2023 (CN) 202321841950.8

(51) Int. Cl. B65H 75/44; H02G 11/00

(52) U.S. Cl. CPC B65H 75/4434; B65H 75/4471; H02G 11/006; B65H 2701/3919

(57) ABSTRACT

The present disclosure provides a retractable data cable, including: a housing, a cable and a cable winding assembly, the housing defines an accommodation cavity, and the cable winding assembly is disposed in the accommodation cavity; the cable winding assembly includes a cable winding reel, the cable winding reel includes a baffle, and the cable is wound around the fixing structure and exposed from the housing; and the fixing structure includes a first fixing block and a second fixing block disposed within the first fixing block, and the cable is clamped between the first fixing block and the second fixing block.

### CROSS-REFERENCE TO RELATED APPLICATION

This application is a continuation application of U.S. Application No. 19/125294, filed on April 28, 2025, which is a National Phase application of PCT Patent Application No. PCT/CN2023/122290, filed on September 27, 2023, which claims the priority of Chinese Patent Application No. 202222618475.X, filed on September 29, 2022 and entitled “RETRACTABLE DATA LINE”, this application also claims the priority of U.S. Patent Application No. 18/880,562, the contents of which are incorporated herein by reference in their entireties.

### TECHNICAL FIELD

The present disclosure relates to the technical field of data cables, in particular to a retractable data cable.

### BACKGROUND

In related art, there is usually no structure for receiving the cable. The cable is directly placed on a desktop or in a bag, and often intertwined with other items on the desktop or in the bag. It is necessary to separate the cable from the wound items before use, which is time-consuming, and results in a poor user experience.

### SUMMARY

In view of this, embodiments of the present disclosure provide a retractable data cable.

The present disclosure provides a retractable data cable, including: a housing, a cable and a cable winding assembly, the housing defines an accommodation cavity, and the cable winding assembly is disposed in the accommodation cavity; the cable winding assembly includes a cable winding reel, the cable winding reel includes a fixing structure, and the cable is wound around the fixing structure and exposed from the housing; and the fixing structure includes a first fixing block and a second fixing block disposed within the first fixing block, and the cable is clamped between the first fixing block and the second fixing block.

### BRIEF DESCRIPTION OF THE DRAWINGS

FIG. 1 is a schematic exploded diagram of a retractable data cable according to some embodiments of the present disclosure.

FIG. 2 is a partial schematic diagram of a cable winding assembly according to some embodiments of the present disclosure.

FIG. 3 is a schematic diagram illustrating a cooperation of a movable assembly and a cable winding assembly according to some embodiments of the present disclosure.

FIG. 4 is a schematic diagram of a swing return member according to some embodiments of the present disclosure.

FIG. 5 is a schematic diagram of an auxiliary member according to some embodiments of the present disclosure.

FIG. 6 is a schematic diagram illustrating a cooperation of an auxiliary member and a swing return member according to some embodiments of the present disclosure.

FIG. 7 is a schematic diagram of a limit gear according to some embodiments of the present disclosure.

FIG. 8 is a schematic diagram of a motion gear according to some embodiments of the present disclosure.

FIG. 9 is a schematic diagram of a rebound assembly according to some embodiments of the present disclosure.

FIG. 10 is a partial schematic diagram of a housing according to some embodiments of the present disclosure.

FIG. 11 is a partial schematic diagram of an optional retractable data cable according to some embodiments of the present disclosure.

FIG. 12 is a partial schematic diagram of an optional retractable data cable according to some embodiments of the present disclosure.

FIG. 13 is a schematic diagram of an optional positioning member according to some embodiments of the present disclosure.

FIG. 14 is a partial cross-sectional diagram of a retractable data cable according to some embodiments of the present disclosure.

### LIST OF REFERENCE NUMERALS

1. Retractable data cable;

10. Housing; 11. Cable; 12. Cable winding assembly; 13. Movable assembly;

100. First limit shaft; 101. Second limit shaft; 102. Central shaft; 103. Fixing member; 111. Output end; 112. Input end; 113. Data cable interface; 120. Cable winding reel; 121. Rebound assembly; 122. Annular partition wall; 130. Driving assembly; 131. Auxiliary member;

1200. Fixing structure; 1203. Baffle; 1210. Coil spring; 1300. Swing return member; 1301. Limit gear; 1302. Motion gear; 1310. Fixed part; 1311. Elastic part;

12001. First fixing block; 12002. Second fixing block; 13000. First cooperating element; 13001. Second cooperating element; 13002. Third cooperating element; 13010. Limit groove; 13011. Return groove; 13020. Recess; 13100. Blind hole;

120010. Opening; 130001. Pushing portion; 130002. Stopping portion;

281. Inner chute; 282. Outer chute; 283. Inlet; 284. Outlet; 285. Clamping groove; 286. First guide protrusion; 287. Second guide protrusion;

600. Positioning member; 610. First seat portion; 620. Positioning protrusion.

### DETAILED DESCRIPTION

In order to make the purposes, the technical solutions and the advantages of the present disclosure to be understood more clearly, the present disclosure will be further described in detail below with reference to the accompanying drawings and embodiments. It should be understood that specific embodiments described herein are merely for explaining the present disclosure and are not intended to limit the present disclosure.

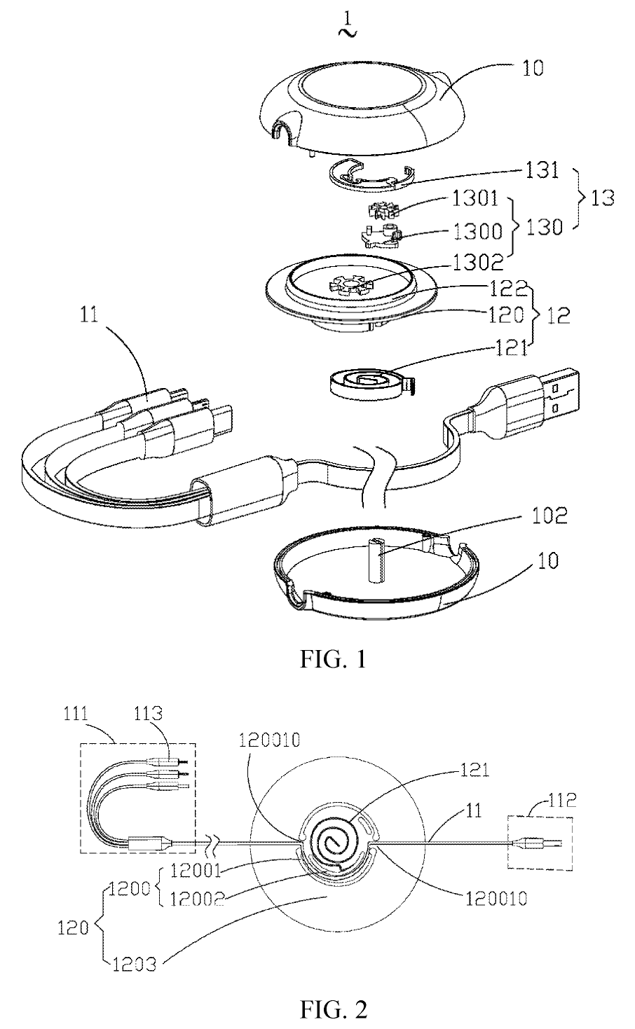

Referring to FIG. 1 and FIG. 2, embodiments of the present disclosure provide a retractable data cable 1, and the retractable data cable 1 includes a housing 10 defining an accommodation cavity, a cable 11, and a cable winding assembly 12 disposed in the accommodation cavity. The cable winding assembly 12 includes a cable winding reel 120, the cable winding reel 120 includes a fixing structure 1200. The cable 11 is wound around the fixing structure 1200 and exposed from the housing 10. The fixing structure 1200 includes a first fixing block 12001 and a second fixing block 12002 disposed within the first fixing block 12001, the cable 11 is clamped between the first fixing block 12001 and the second fixing block 12002.

It can be understood that through the cable winding assembly 12, the cable 11 can be pulled out of the cable winding assembly 12, or the excess portion of the cable 11 can be retracted into the cable winding assembly 12, to realize the free extension and retraction of the data cable. The fixing structure 1200 is configured to fix the cable 11, to allow the cable 11 to be wound around an outer periphery of the fixing structure 1200 during the extension and retraction of the cable 11. It can be understood that a portion of the cable 11 is clamped between the first fixing block 12001 and the second fixing block 12002, and two ends of the cable 11 pass through the first fixing block 12001 and are exposed from the housing 10.

In some embodiments, the first fixing block 12001 and the second fixing block 12002 are provided as an arc-shaped structure, and the first fixing block 12001 and the second fixing block 12002 are disposed coaxially.

Optionally, the first fixing block 12001 is provided as an annular structure, which is convenient for the cable 11 to be wound around an outer periphery of the first fixing block 12001 when it is retracted, the second fixing block 12002 is provided as an arc-shaped structure, and the first fixing block 12001 and the second fixing block 12002 are disposed coaxially. In addition, the first fixing block 12001 is provided with two openings 120010, and the housing 10 is provided with two through holes correspondingly. Each of the two ends of the cable 11 passes through a corresponding one of the two openings 120010 and a corresponding one of the two through holes successively and is exposed. It should be noted that when the cable 11 needs to be shortened, the cable winding reel 120 rotates clockwise/counterclockwise, and two sections of the cable 11 passing through the first fixing block 12001 are respectively wound clockwise/counterclockwise around the outer periphery of the first fixing block 12001. When the cable 11 needs to be extended, the cable winding reel 120 rotates counterclockwise/clockwise, and each of the two sections of the cable 11 wound around the outer periphery of the first fixing block 12001 extends out of the housing 10 through a corresponding one of the two through holes.

It can be understood that in order to make the thickness of the sections of the cable 11 wound around the outer periphery of the first fixing block 12001 as uniform as possible, the two openings 120010 may be disposed on the first fixing block 12001 opposite to each other along a direction perpendicular to a rotation axis of the baffle 1203. That is, the two openings 120010 and an axis center of the first fixing block 12001 are located on the same straight line.

The cable wingding assembly 12 of the retractable data cable 1 in the embodiments of the present disclosure may further include a cable controlling structure. The cable controlling structure can cooperate with the cable winding reel 120 to achieve the extension and retraction of the cable 11.

In some embodiments, the cable controlling structure may include an operating member (not shown in the figure) connected to the cable winding reel 120, and a portion of the operating member passes through an opening of the housing 10 and protrudes out of the housing 10. When the operator pulls one or two ends of the cable 130 located outside the housing 10, the cable winding reel 120 drives the operating member to rotate in the opening. When the operator stops pulling one or two ends of the cable 130 located outside the housing 10, the cable winding reel 120 directly stops rotating due to a friction force between the cable winding reel 120 and the housing 10. When it is needed to receive the portion of the cable 11 located outside the housing 10 in the cable winding reel 120, the operating member may be manually rotated to enable the operating member to drive the cable winding reel 120 to rotate in an opposite direction, so that the portion of the cable 11 located outside the housing 10 can be wound around the fixing structure 1200, thereby achieving the retraction of the cable 11.

In some embodiments, the cable controlling structure may include a rebound assembly (for example, the rebound assembly 121 in FIG. 1) and a positioning assembly. That is, the cable winding assembly 12 of the present disclosure may include a rebound assembly 121 and a positioning assembly, and the rebound assembly 121 and the positioning assembly can cooperate with the cable winding reel 120 to achieve the extension and retraction as well as the position locking and unlocking.

In the following, it is taken as an example that the rebound assembly is provided to illustrate the retractable data cable 1 in the embodiments of the present disclosure. It can be understood that only one of the rebound assembly 121 and the operating member can be disposed in the retractable data cable 1 of the present disclosure, or both the rebound assembly 121 and the operating member can be disposed in the retractable data cable 1 of the present disclosure, and the embodiments of the present disclosure are not limited herein.

In some embodiments, the cable winding assembly 12 of the present disclosure may further include a rebound assembly 121, the rebound assembly 121 is disposed in the fixing structure 1200. The housing 10 is further provided with a central shaft 102, and the fixing structure 1200 and the central shaft 102 are rotatably connected. Two ends of the rebound assembly 121 are respectively connected to the central shaft 102 and the fixing structure 1200.

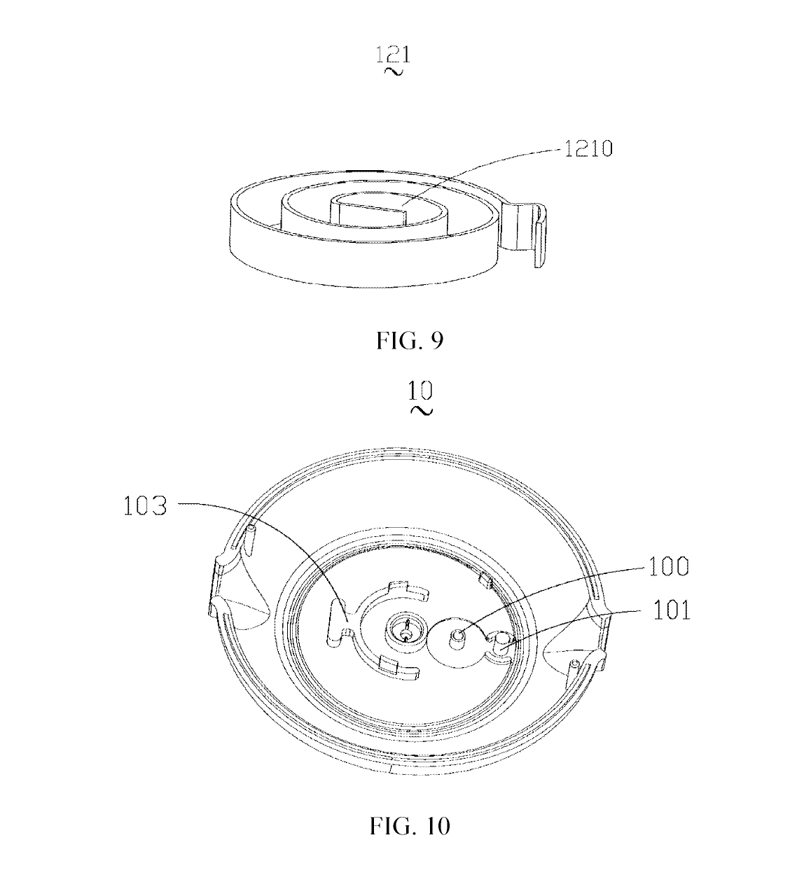

Optionally, referring to FIG. 1, FIG. 2 and FIG. 9, the rebound assembly 121 may include a coil spring 1210, and the housing 10 is provided with the central shaft 102. One of two ends of the coil spring 1210 is connected to the central shaft 102, and another one of the two ends of the coil spring 1210 is connected to the second fixing block 12002. It should be noted that the rebound assembly 121 in the present embodiment adopts the coil spring 1210, which has a simple structure and is convenient for installation and replacement. The end of the coil spring 1210 connected to the second fixing block 12002 is a free end, and the end of the coil spring 1210 connected to the central shaft 102 is a fixed end. When the cable 11 is pulled out by the user, the cable winding reel 120 rotates to drive the free end of the coil spring 1210 to rotate, and the coil spring 1210 is elastically deformed. When the cable 11 needs to be shortened, the cable winding reel 120 is driven to rotate in the opposite direction under the action of the coil spring 1210, to allow the cable 11 to be wound around the outer periphery of the first fixing block 12001.

It can be understood that the rebound assembly 121 in the present disclosure can also adopt other approaches besides the coil spring, as long as the cable 11 is allowed to be retracted under the action of the rebound assembly 121, and which is not limited in the present disclosure.

Optionally, the second fixing block 12002 in the embodiments can be provided as an arc-shaped structure, and the diameter of the circle corresponding to the arc-shaped structure is greater than or equal to 20mm and less than or equal to 30mm.

The rebound assembly 121 is disposed within the second fixing block 12002, and under the action of an external force, the cable 11 extends and the cable winding reel 120 rotates, and the rebound assembly 121 generates elastic potential energy. When the cable 11 needs to be shortened, under the action of the rebound assembly 121, the cable winding reel 120 rotates in the opposite direction, to allow the cable 11 to be wound around the outer periphery of the first fixing block 12001. The rebound assembly 121 is disposed within the second fixing block 12002. In this way, the position where the rebound assembly 121 originally needs to be specially placed is omitted, and the size in the thickness direction of the cable winding assembly 12 is reduced.

In some embodiments, the cable winding assembly 12 of the present disclosure may include a rebound assembly 121, the rebound assembly 121 may be disposed between the housing 10 and the cable winding reel 120. One end of the rebound assembly 121 is connected to the cable winding reel 120, and the other end of the rebound assembly 121 is connected to the housing 10.

Optionally, in the embodiments of the present disclosure, the second fixing block 12002 is provided as an arc-shaped structure, and the diameter of the circle corresponding to the arc-shaped structure is greater than or equal to 3mm and less than or equal to 10mm.

In the embodiments of the present disclosure, the rebound assembly 121 is disposed between the housing 10 and the cable winding reel 120, i.e., the rebound assembly 121 is not disposed in the fixing structure 1200. In this case, the rebound assembly 121 and the fixing structure 1200 can be located in two planes. For example, a baffle can be disposed between the rebound assembly 121 and the fixing structure 1200, the rebound assembly 121 can be disposed on one side of the baffle, and the fixing structure 1200 can be disposed on the side of the baffle away from the rebound assembly 121. In this way, the size of the retractable data cable 1 in the radial direction can be reduced.

Referring to FIG. 1 and FIG. 2, in some embodiments, the cable winding reel 120 of the present disclosure may further include a baffle 1203, the baffle 1203 is disposed on one side of the fixing structure 1200, and an end of the fixing structure 1200 away from the baffle 1203 directly abuts against an inner wall of the housing 10.

The end of the fixing structure 1200 away from the baffle 1203 abuts against the inner wall of the housing 10. That is, the cable 11 is disposed between the baffle 1203 and the inner wall of the housing 10. In this way, when the cable 11 is wound around the fixing structure 1200, the baffle 1203 and the housing 10 can limit a winding section of the cable 11 to prevent the cable 11 from being disengaged from the cable winding reel 120.

In the embodiments of the present disclosure, two ends of the first fixing block 12001 are closed by the baffle 1203 and the housing 10 respectively, so that the cable 11 can be restricted, which can help to reduce the space occupied by the retractable data cable.

In the embodiments of the present disclosure, the retractable data cable 1 can be provided with the rebound assembly 121 or the operating member as described in the above embodiments. It is taken as an example that the rebound assembly 121 can be installed within the fixing structure 1200, when the rebound assembly121 is provided. That means, the rebound assembly 121 and the fixing structure 1200 are located on the same side of the baffle 1203. In such case, the size of the retractable data cable 1 in the thickness direction can be reduced. Alternatively, the rebound assembly 121 can be disposed on the side of the baffle 1203 away from the fixing structure 1200, that is, the rebound assembly 121 and the fixing structure 1200 are located on two sides of the baffle 1203. In such case, the size of the retractable data cable 1 in the radial direction can be reduced.

In order to achieve position locking and unlocking of the cable 11 at any extending length during the extension, the retractable data cable 1 of the present disclosure may further include a positioning assembly.

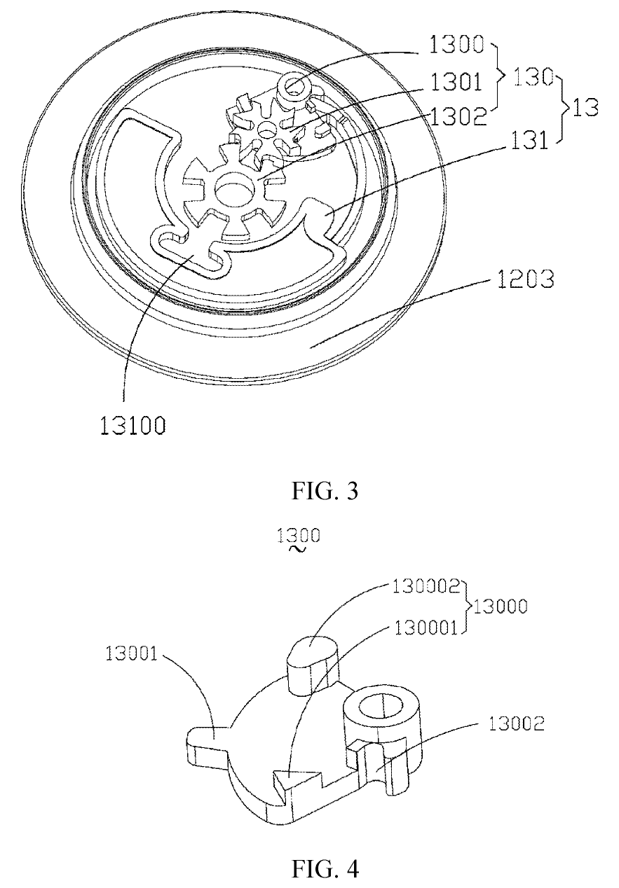

Referring to FIG. 1 and FIG. 3, in some embodiments, the positioning assembly of the present disclosure may include a movable assembly. Specifically, the cable winding reel 120 may further include a baffle 1203 and a movable assembly 13, the baffle 1203 is disposed on one side of the fixing structure 1200, and the movable assembly 13 is disposed on a side of the baffle 1203 away from the fixing structure 1200. The movable assembly 13 includes a driving assembly 130 cooperating with the baffle 1203 and an auxiliary member 131 fixedly connected to the housing 10. The auxiliary member 131 cooperates with the driving assembly 130. The rotation of the cable winding assembly 12 drives the driving assembly 130 to move and thus causes the auxiliary member 131 to elastically deform, this elastic deformation provides an elastic restoring force for the driving assembly 130 to restore the initial state.

It can be understood that the cable 11 wound around the first fixing block 12001 can be freely extended or retracted through the cable winding assembly 12 disposed in the retractable data cable 1. By providing the movable assembly 13, the movable assembly 13 can position the cable 11 when the cable 11 wound around the cable winding reel 120 is extended by any length. When the user extends the cable 11 by a suitable length, the user can directly release the cable 11, and the cooperation of the cable winding reel 120 and the driving assembly 130 in the movable assembly 13 allows the cable 11 to maintain the length thereof for use. It can be seen that the design of the cooperation of the movable assembly 13 and the cable winding reel 120 simplifies the structure of the adjusting device of the retractable charger, and effectively improves the practicability of the retractable data cable 1.

Further, referring to FIG. 1, an annular partition wall 122 is disposed on a side of the baffle 1203 close to the movable assembly 13, the annular partition wall 122 and the housing 10 together define a partitioned cavity, and the movable assembly 13 is disposed in the partitioned cavity.

It can be understood that the movable assembly 13 is disposed in the partitioned cavity, and under the action of the annular partition wall 122 and the housing 10, the interference of external factors is minimized, the cable 11 is prevented from not being smoothly extended or retracted due to the entry of a large amount of dust into the movable assembly 13, and the service life of the device is prolonged.

Optionally, at least a portion of the housing 10 can be provided as a transparent area, for example, the area of the housing 10 corresponding to the movable assembly 13 or the area of the housing 10 corresponding to the fixing structure 1200, so that the user can conveniently observe the internal structure of the housing 10 and the sense of design is improved.

In some embodiments, the driving assembly 130 may include a motion gear 1302, a limit gear 1301, and a swing return member 1300. The motion gear 1302 is fixedly connected to the baffle 1203. The swing return member 1300 is disposed among the motion gear 1302, the limit gear 1301 and the auxiliary member 131.

In some embodiments, referring to FIG. 4 to FIG. 6, the swing return member 1300 includes a first cooperating element 13000 cooperating with the limit gear 1301, a second cooperating element 13001 cooperating with the motion gear 1302, and a third cooperating element 13002 cooperating with the auxiliary member 131. The third cooperating element 13002 can cooperate with the auxiliary member 131 to provide a pre-tightening force for the swing return member 1300 to swing toward or away from a side of the auxiliary member 131.

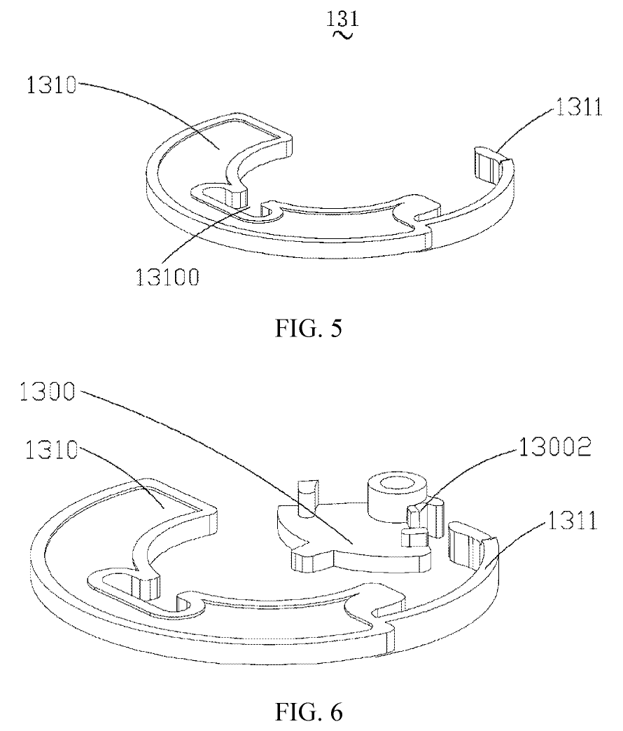

In some embodiments, referring to FIG. 5 and FIG. 6, the auxiliary member 131 includes a fixed part 1310 and an elastic part 1311, the fixed part 1310 is connected to the elastic part 1311, and an end of the elastic part 1311 away from the fixed part 1310 cooperates with the third cooperating element 13002. The fixed part 1310 can be connected to the housing 10 to allow the auxiliary member 131 to be fixed, to prevent the displacement of the auxiliary member 131. An end of the elastic part 1311 cooperating with the third cooperating element 13002 can move within a certain range to provide a stable pre-tightening force for the swing return member 1300. It can be understood that the magnitude of the pre-tightening force is relevant to the length of the elastic part 1311. Therefore, the magnitude of the pre-tightening force can be adjusted by adjusting the length of the elastic part 1311 without changing the material used.

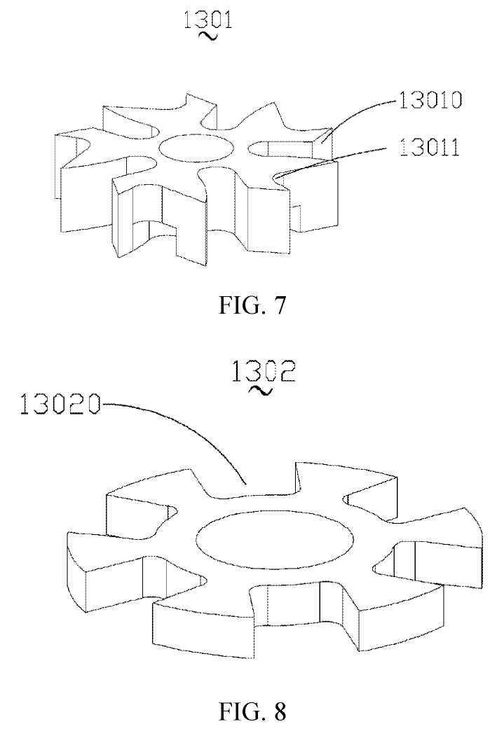

In some embodiments, referring to FIG. 4 and FIG. 7, the first cooperating element 13000 includes a pushing portion 130001 and a stopping portion 130002. Each of the pushing portion 130001 and the stopping portion 130002 is provided at a corresponding one of two ends of the swing return member 1300 and cooperates with the limit gear 1301. Specifically, the limit gear 1301 is provided with a limit groove 13010 and a return groove 13011 that cooperate with the stopping portion 130002, and the limit groove 13010 and the return groove 13011 are spaced apart from each other. The stopping portion 130002 cooperates with the limit groove 13010 to allow a limitation of the motion gear 1302. The stopping portion 130002 cooperates with the return groove 13011 to release the limitation of the motion gear 1302.

Optionally, the limit groove 13010 and the return groove 13011 may have different depths in the radial direction of the limit gear 1301. Specifically, the depth of the return groove 13011 in the radial direction of the limit gear 1301 is greater than the depth of the limit groove 13010 in the radial direction of the limit gear 1301.

In some embodiments, referring to FIG. 4 and FIG. 8, the motion gear 1302 is provided with at least six recesses 13020, and the second cooperating element 13001 is provided with a protrusion cooperating with the recesses 13020. It should be noted that the recesses 13020 in the present embodiment can be understood as a tooth space of the motion gear 1302, the protrusion provided on the second cooperating element 13001 can cooperate with the recesses 13020. At least six recesses 13020 are provided, which can ensure that when the motion gear 1302 rotates, the swing return member 1300 will not be in a state of not cooperating with the recesses 13020 for a long time, thereby avoiding the situation that the cable 11 cannot be stopped in time. In addition, seven or eight, or less than seven recesses 13020 or the like may be provided, and the recesses 13020 are evenly distributed on the motion gear 1302. The more recesses 13020 are, when the user extends the cable 11, the cable 11 can be stopped in time, and the cable 11 can be extended out by an appropriate length as needed.

In the embodiments of the present disclosure, when the cable 11 is pulled by the user to extend, the cable winding reel 120 and the motion gear 1302 rotate synchronously, the motion gear 1302 drives the swing return member 1300 to rotate to one side. When the swing return member 1300 rotates, the pushing portion 130001 pushes the limit gear 1301 to rotate. In the situation where the limit groove 13010 is pushed to a preset position, the second cooperating element 13001 provided on the swing return member 1300 slides out of the recess 13020 of the motion gear 1302. At this time, the elastic part 1311 of the auxiliary member 131 cooperating with the swing return member 1300 is elastically deformed to provide an elastic force for the swing return member 1300, to allow the swing return member 1300 to rebound in an opposite side when no pulling force is provided, so that the swing return member 1300 can cooperate with the next recess 13020 of the motion gear 1302 to realize the position locking of the cable 11. In the situation where the return groove 13011 is pushed to a preset position, when the cable 11 is released, the swing return member 1300 swings back under the action of the elastic force, the stopping portion 130002 cooperates with the return groove 13011, the second cooperating element 13001 provided on the swing return member 1300 no longer cooperates with the recess 13020 of the motion gear 1302 to complete the retraction of the cable 11.

It can be understood that the movable assembly 13 can cooperate with the rebound assembly 121 in the embodiments of the present disclosure to achieve the extension and retraction as well as the position locking and unlocking of the cable 11. Specifically, when the cable 11 is pulled to extend, the motion gear 1302 drives the swing return member 1300 to swing by the second cooperating element 13001, to urge the pushing portion 130001 to come into contact with the limit gear 1301 and push the limit gear 1301 to rotate. When the extension ceases, the cable winding reel 120 rotates back by a short distance under the action of the rebound assembly 121. At this time, the stopping portion 130002 of the swing return member 1300 cooperates with the limit groove 13010 of the limit gear 1301 to fix the swing return member 1300 at the current position, thereby fixing the motion gear 1302 cooperating with the second cooperating element 13001 at the current position, and thus achieving the fixation of the cable winding reel 120 and the cable 11. When the cable 11 needs to be retracted, the cable 11 is pulled to extend by an appropriate distance, and the swing return member 1300 is driven to swing by a certain distance through the cooperation of the recesses 13020 provided on the motion gear 1302 and the protrusion of the second cooperating element, to urge the pushing portion 130001 to push the limit gear 1301 to rotate, to allow the return groove 13011 to rotate to a predetermined position. When the cable is released, since the motion gear 1302 rotates back and there is the pre-tightening force, the swing return member 1300 swings back, and the stopping portion 130002 cooperates with the return groove 13011. At this time, the second cooperating element 13001 no longer cooperates with the recesses 13020 of the motion gear 1302, and the motion gear 1302 drives the cable winding reel 120 to rotate back, to complete the retraction of the cable 11.

In some embodiments, referring to FIG. 10, the housing 10 can be further provided with a first limit shaft 100 and a second limit shaft 101, the first limit shaft 100 is rotatably connected to the limit gear 1301, and the second limit shaft 101 is rotatably connected to the swing return member 1300.

It can be understood that each of the swing return member 1300 and an axial center of the limit gear 1301 may be provided with a through hole, the first limit shaft 100 is rotatably connected to the limit gear 1301, and the second limit shaft 101 is rotatably connected to the swing return member 1300, to limit the limit gear 1301 and the swing return member, to prevent the displacement of the limit gear 1301 and the swing return member 1300.

In some embodiments, continuing referring to FIG. 10, the housing 10 is provided with a fixing member 103 configured to fix the fixed part 1310. It should be noted that the auxiliary member 131 is connected to the housing 10 through the fixing member 103, and the fixing member 103 is configured to limit the fixed part 1310. The fixed part 1310 of the auxiliary member 131 may be provided with at least one blind hole 13100, and the shape of the blind hole 13100 may be a regular shape such as a circular hole, a square hole, or may be a profile hole with an irregular shape. The fixing member 103 cooperates with the blind hole 13100 of the fixed part 1310 or corresponds to the shape of the fixed part 1310 itself to prevent the displacement of the fixed part 1310, to allow the auxiliary member 131 to cooperate with the driving assembly 130. In addition, in case that the auxiliary member 131 is damaged, the cooperating manner of the fixing member 103 and the auxiliary member 131 is convenient for disassembling and replacement.

In some embodiments, a central shaft 102 is provided on the housing 10, the motion gear 1302 and the baffle 1203 are jointly sleeved on the central shaft 102. It can be understood that in case that the first fixing block 12001 has an annular structure, an axial center of the central shaft 102 is also the axial center of the first fixing block 12001. When the cable 11 is pulled to extend or is shortened, the cable winding reel 120 rotates about the central shaft 102. The motion gear 1302 is sleeved on the central shaft 102 to allow the motion gear 1302 to be limited, that is, the motion gear 1302 can rotate about the central shaft 102 without displacement.

Exemplarily, an initial state of the retractable data cable 1 is a retracted state. When the data cable is used, the cable 11 is pulled to extend, and the extension of the cable 11 drives the cable winding reel 120 to rotate about the central shaft 102. On the one hand, the coil spring 1210 fixedly connected to the second fixing block 12002 rotates synchronously with the rotation of the cable winding reel 120, and the coil spring 1210 generates elastic potential energy. On the other hand, the motion gear 1302 fixedly connected to the cable winding reel 120 rotates synchronously with the rotation of the cable winding reel 120, to drive the swing return member 1300 cooperating with the motion gear 1302 to rotate to one side. When the swing return member 1300 rotates, the pushing portion 130001 pushes the limit gear 1301 to rotate, and pushes the limit groove 13010 to a preset position. When the swing return member 1300 swings by a certain distance, the second cooperating element 13001 provided on the swing return member 1300 slides out of the tooth space of the motion gear 1302. At this time, the elastic part 1311 of the auxiliary member 131 cooperating with the swing return member 1300 is elastically deformed to provide a pre-tightening force for the swing return member 1300, to allow the swing return member 1300 to rebound an opposite side and cooperate with the next recess 13020 of the motion gear 1302. After the cable 11 is extended by an appropriate length, an elastic force of the coil spring 1210 causes the cable winding reel 120 to rotate back and drives the motion gear 1302 to rotate back. Since the motion gear 1302 rotates back and there is the pre-tightening force, the stopping portion 130002 provided on the swing return member 1300 cooperates with the limit groove 13010 of the limit gear 1301 to fix the swing return member 1300 at the current position, that is, the second cooperating element 13001 provided on the swing return member 1300 cooperates with the motion gear 1302 and is fixed at the current position, thereby achieving the stopping of the cable winding reel 120 and the cable 11.

When the cable 11 needs to be retracted, the cable 11 is pulled to extend by a short distance, to allow the motion gear 1302 to drive the swing return member 1300 to swing by a short distance, to allow the pushing portion 130001 to push the limit gear 1301 and push the return groove 13011 to a preset position. When the cable is released, the swing return member 1300 swings back, to allow the stopping portion 130002 to cooperate with the return groove 13011, and allow the swing return member 1300 to be fixed at the current position. At this time, the second cooperating element 13001 provided on the swing return member 1300 no longer cooperates with the motion gear 1302, and the motion gear 1302 is not prevented from rotating back. The cable winding reel 120 rotates back under the action of the elastic force of the coil spring 1210 to complete the retraction of the cable 11.

In the above embodiments, the positioning assembly of the present disclosure can achieve the extension and retraction as well as the position locking and unlocking of the cable 11 through the elastic deformation of the movable assembly 13. Specifically, the movable assembly 13 achieves the swinging of the swing return assembly 1300 through the elastic force generated by the elastic part 1311 of the auxiliary member 131, thereby completing the extension and retraction as well as the position locking and unlocking of the cable 11. In some embodiments, the positioning assembly of the present disclosure can further achieve the extension and retraction as well as the position locking and unlocking of the cable 11 through magnetic attraction.

Specifically, referring to FIG. 3, in some embodiments, the positioning assembly of the present disclosure includes a limit gear 1301, a motion gear 1302, a swing return member 1300, and an auxiliary member 131. The motion gear 1302 is disposed on the cable winding reel 120, the swing return member 1300 and the limit gear 1301 are rotatably disposed on the housing 10, and the auxiliary member 131 is disposed on the housing 10 and has magnetic attraction with the swing return member 1300.

Optionally, one of the auxiliary member 131 and the swing return member 1300 is a magnet, and the other one thereof is a magnetic conducting member. Alternatively, both the auxiliary member 131 and the swing return member 1300 are magnets. In the embodiments, it is taken as an example that the auxiliary member 131 is a magnet, and the swing return member 1300 is a magnetic conducting member.

The magnetic member can be magnetized. Specifically, it can be made of magnetic materials such as iron.

In the embodiment of the present disclosure, the motion gear 1302 is provided with at least one recess 13020, and the swing return member 1300 is provided with a second cooperating element 13001, the second cooperating element 13001 can cooperate with the recess 13020. The swing return member 1300 is further provided with a pushing portion 130001 and a stopping portion 130002 that are protruding in the axial direction, and the limit gear 1301 is located between the pushing portion 130001 and the stopping portion 130002. The limit gear 1301 is provided with a limit groove 13010 cooperating with the stopping portion 130002 and a return groove 13011 cooperating with the pushing portion 130001, and the limit groove 13010 and the return groove 13011 are spaced apart from each other.

When the cable 11 is pulled to extend, the cable winding reel 120 and the motion gear 1302 rotate synchronously, the motion gear 1302 drives the swing return member 1300 to rotate to one side. When the swing return member 1300 rotates, the pushing portion 130001 pushes the limit gear 1301 to rotate. In the situation where the limit groove 13010 is pushed to a preset position, the second cooperating element 13001 provided on the swing return member 1300 slides out of the recess 13020 of the motion gear 1302. At this time, the auxiliary member 131 cooperating with the swing return member 1300 provides a magnetic force for the swing return member 1300, to allow the swing return member 1300 to rebound in an opposite side when no pulling force is provided for the cable 11, so that the swing return member 1300 can cooperate with the next recess 13020 of the motion gear 1302 to realize the position locking of the cable 11. In the situation where the return groove 13011 is pushed to a preset position, when the cable 11 is released, the swing return member 1300 swings back under the attraction force of the auxiliary member 131, the stopping portion 130002 cooperates with the return groove 13011, and the second cooperating element 13001 provided on the swing return member 1300 no longer cooperates with the recess 13020 of the motion gear 1302 to complete the retraction of the cable 11.

In some embodiments, the positioning assembly of the present disclosure can also achieve the extension and retraction as well as the position locking and unlocking of the cable 11 through a chute.

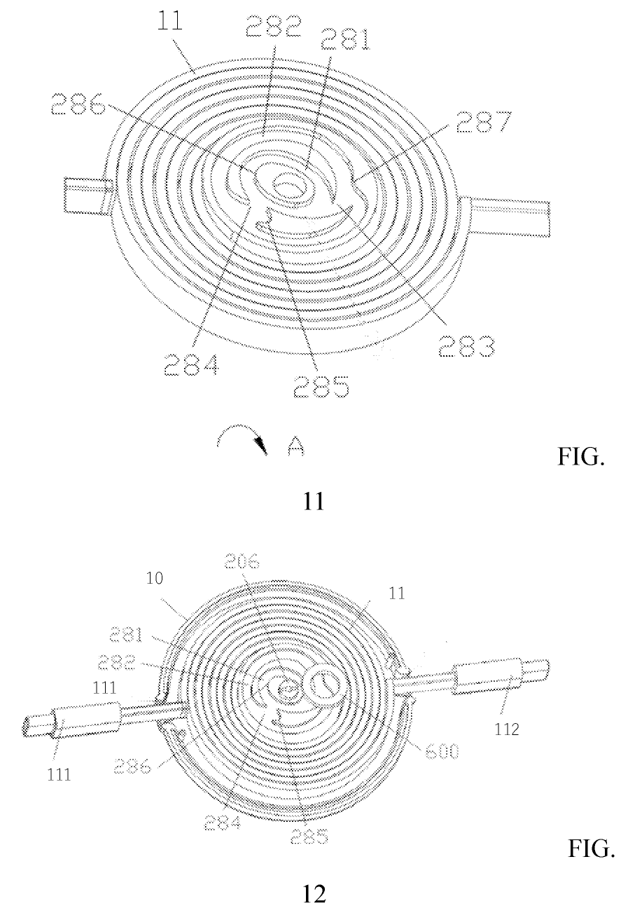

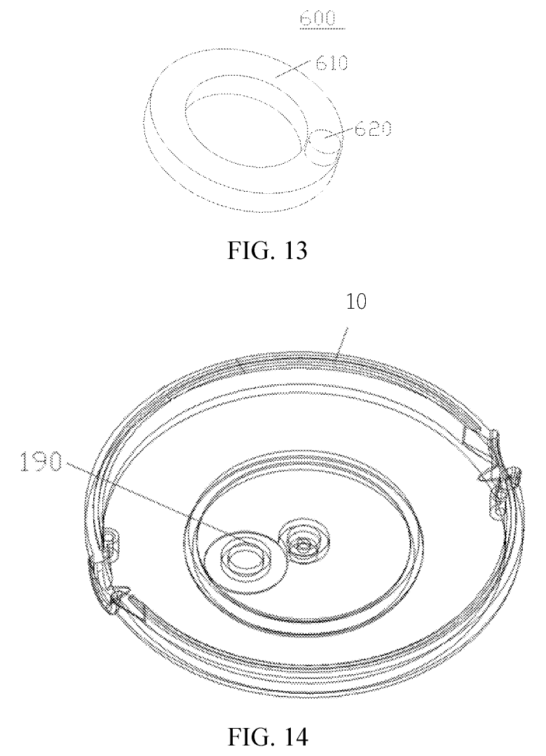

Specifically, referring to FIG. 11 to FIG. 14, in some embodiments of the present disclosure, one of the cable winding reel 120 and the housing 10 is provided with an inner chute 281 in annular shape and an outer chute 282 in annular shape that are spaced apart, and the other one of the cable winding reel 120 and the housing 10 is provided with a positioning member 600. An inlet 283 and an outlet 284 communicated with each other are formed between the inner chute 281 and the outer chute 282, and a clamping groove 285 is provided at the outlet 284. The positioning member 600 includes a first seat portion 610 and a positioning protrusion 620 protruded from an end surface of the first seat portion 610. The positioning protrusion 620 is configured to be engaged in the clamping groove 285, to limit a rotation position of the cable winding reel 120 relative to the housing 10.

The retractable data cable 1 in the embodiments may further include the rebound assembly 121 described in the above embodiments, which can cooperate with the inner chute 281 and the outer chute 282 to achieve the extension and retraction as well as the position locking and unlocking of the cable 11. Specifically, when one or two ends of the cable 11 located outside the housing 10 ae pulled, the cable winding reel 120 rotates in the first direction A, the positioning protrusion 620 slides in the inner chute 281, and the rebound assembly 121 deforms. When the length of the cable 11 extended out of the housing meets usage requirements, the operator may stop pulling one or two ends of the cable 11 located outside the housing 10, and at this time, the cable winding reel 120 rotates in a second direction opposite to the first direction A under an action of the deformation force of the rebound assembly 121. Then the positioning protrusion 620 slides to be engaged in the clamping groove 285, so that the cable winding reel 120 stops rotating relative to the housing 10, thereby keeping a length of the cable 11 located outside the housing 10 unchanged. When the cable 11 needs to be received, the operator gently pulls one or two ends of the cable 11 located outside the housing 10, to force the positioning protrusion 620 to disengage from the clamping groove 285 and enter the outer chute 282 from the outlet 284. The cable winding reel 120 continues to rotate in the second direction opposite to the first direction A under the action of the deformation force of the rebound assembly 121, to drive the portion of the cable 11 located outside the housing 10 to enter the housing 10, so as to receive the cable 11. When the length of the cable 11 needs to increase again, the operator may pull one or two ends of the cable 11 located outside the housing 10 again, and at this time, the cable winding reel 120 rotates in the first direction A, and the positioning protrusion 620 firstly slides in the outer chute 282 and slides into the inlet 283, and then the positioning protrusion 620 enters the inner chute 281 from the inlet 283 and slides in the inner chute 281.

In the embodiments, the shape of each of the inner chute 281 and the outer chute 282 is not limited, as long as the positioning protrusion 620 may enter the inner chute 281 from the outer chute 282 through the inlet 283 when the cable winding reel 120 rotates in the first direction A, and the positioning protrusion 620 may be engaged in the clamping groove 285 and may enter the outer chute 282 from the clamping groove 285 through the outlet 284 when the cable winding reel 120 rotates in the second direction opposite to the first direction A.

Optionally, the cable winding reel 120 is provided with a first guide protrusion 286 at an inner sidewall of the inner chute 281. The first guide protrusion 286 is located at the outlet 284, to guide the positioning protrusion 620 to slide into the clamping groove 285 at the outlet 284. The cable winding reel 120 is provided with a second guide protrusion 287 on an outer sidewall of the outer chute 282. The second guide protrusion 287 is located at the inlet 283, to guide the positioning protrusion 620 to slide into the inner chute 281 from the inlet 283.

In the embodiments, the structure of the first seat portion 610 is not limited. For example, as shown in FIG. 12 and FIG. 14, the first seat portion 610 may be an annular structure, and the housing 10 further includes a first protruded column 190 inserted into an inner cavity of the first seat portion 610, so that rotatable connection of the positioning member 600 and the housing 10 is achieved by inserting the first protruded column 190 into the inner cavity of the first seat portion 610. In addition, the presence of the annular first seat portion 610 may reduce space for arranging the positioning member 600.

Optionally, the positioning assembly of the present disclosure can be further provided with a chute and a ball, and the position locking and unlocking of the cable 11 during the extension process can be achieved through the cooperation of the chute and the ball. The specific implementation of the positioning assembly in the present disclosure is not limited.

Further, referring to FIG. 2, an end of the cable 11 is defined as an output end 111, another end of the cable 11 is defined as an input end 112, and the output end 111 and/or the input end 112 include at least one data cable interface 113.

It should be noted that the retractable data cable 1 provided in the embodiments may perform one-to-one, one-to-multiple, or multiple-to-multiple charging or data transmission. Specifically, there may be one or multiple data cable interfaces 113 located at the input end 112, and there may be one or multiple data cable interfaces 113 located at the output end 111. The present embodiments are not specifically limited thereto, and it is beneficial to expanding the scope of use of the retractable data cable 1 and enhancing the practicality of the present disclosure.

Further, the data cable interface 113 includes one or more of mini, micro, Lightning, Type-C and USB-A, and the data cable interface 113 is a magnetic suction interface or a mechanical plug-in interface.

Exemplarily, each of the data cable interfaces 113 located at the input end 112 and the output end 111 may be a Type-C interface (Type-C to Type-C). The data cable interface 113 located at the input end 112 is a USB-A interface, and the data cable interface 113 located at the output end 111 is a Type-C interface (USB-A to Type-C). It can be understood that the retractable data cable 1 provided in the present embodiment can achieve Type-C to Type-C, USB-A to Type-C and the like for charging or data transmission. The data cable interface 113 is a magnetic suction interface or a mechanical plug-in interface, which is beneficial to making the retractable data cable 1 of the present disclosure suitable for different usage situations and enhancing the adaptability of the retractable data cable 1.

What is claimed is:

1. A retractable data cable, comprising:
a housing, a cable and a cable winding assembly, wherein the housing defines an accommodation cavity, and the cable winding assembly is disposed in the accommodation cavity;
wherein the cable winding assembly comprises a cable winding reel, the cable winding reel comprises a fixing structure, and the cable is wound around the fixing structure and exposed from the housing; and
wherein the fixing structure comprises a first fixing block and a second fixing block disposed within the first fixing block, and the cable is clamped between the first fixing block and the second fixing block.

2. The retractable data cable according to claim 1, wherein each of the first fixing block and the second fixing block has an arc-shaped structure, and the first fixing block and the second fixing block are disposed coaxially.

3. The retractable data cable according to claim 1, wherein the cable winding reel further comprises a baffle, the baffle is disposed on one side of the fixing structure, and an end of the fixing structure away from the baffle directly abuts against an inner wall of the housing.

4. The retractable data cable according to claim 1, wherein the retractable data cable further comprises a baffle and a movable assembly, the baffle is disposed on one side of the fixing structure, and the movable assembly is disposed on a side of the baffle away from the fixing structure; and
wherein the movable assembly comprises a driving assembly cooperating with the baffle and an auxiliary member fixedly connected to the housing, the auxiliary member cooperates with the driving assembly, a rotation of the cable winding assembly drives the driving assembly to move and causes the auxiliary member to generate elastic deformation, and the elastic deformation provides an elastic restoring force for the driving assembly to restore an initial state.

5. The retractable data cable according to claim 4, wherein the driving assembly comprises a motion gear, a limit gear and a swing return member, and the motion gear is fixedly connected to the baffle; and
wherein the swing return member is disposed between the motion gear and the auxiliary member, the swing return member comprises a first cooperating element cooperating with the limit gear, a second cooperating element cooperating with the motion gear, and a third cooperating element cooperating with the auxiliary member.

6. The retractable data cable according to claim 5, wherein the auxiliary member comprises a fixed part and an elastic part, the elastic part cooperates with the third cooperating element, and the fixed part is connected to the housing.

7. The retractable data cable according to claim 5, wherein the first cooperating element comprises a pushing portion and a stopping portion, and each of the pushing portion and the stopping portion is provided at a corresponding one of two ends of the swing return member and cooperates with the limit gear.

8. The retractable data cable according to claim 7, wherein the limit gear is provided with a limit groove and a return groove that cooperate with the stopping portion, and the limit groove and the return groove are spaced apart from each other;
wherein the stopping portion cooperates with the limit groove to allow a limitation of the motion gear; and
wherein the stopping portion cooperates with the return groove to release the limitation of the motion gear.

9. The retractable data cable according to claim 8, wherein in a case that the cable is pulled to extend, the cable winding reel and the motion gear rotate synchronously, and the motion gear drives the swing return member to rotate to one side;
when the swing return member rotates, the pushing portion pushes the limit gear to rotate;
in a situation where the limit groove is pushed to a preset position:
the second cooperating element provided on the swing return member slides out of one of recesses of the motion gear, an elastic part of the auxiliary member cooperating with the swing return member is elastically deformed to provide an elastic force for the swing return member, to allow the swing return member to rebound in an opposite side when no pulling force is provided for the cable, so that the swing return member cooperates with a next one of the recesses of the motion gear to realize position locking of the cable; and
in a situation where the return groove is pushed to a preset position:
in a case that the cable is released, the swing return member swings back under an action of the elastic force, the stopping portion cooperates with the return groove, the second cooperating element provided on the swing return member no longer cooperates with the recesses of the motion gear to complete retraction of the cable.

10. The retractable data cable according to claim 8, wherein a depth of the limit groove in a radial direction of the limit gear and a depth of the return groove in the radial direction of the limit gear are different.

11. The retractable data cable according to claim 10, wherein the depth of the return groove in the radial direction of the limit gear is greater than the depth of the limit groove in the radial direction of the limit gear.

12. The retractable data cable according to claim 5, wherein the housing is provided with a first limit shaft and a second limit shaft, the first limit shaft is rotatably connected to the limit gear, and the second limit shaft is rotatably connected to the swing return member.

13. The retractable data cable according to claim 1, wherein the cable winding assembly further comprises a rebound assembly, the rebound assembly is disposed within the fixing structure, the housing is provided with a central shaft, the fixing structure is rotatably connected to the central shaft, and two ends of the rebound assembly are respectively connected to the central shaft and the fixing structure.

14. The retractable data cable according to claim 13, wherein the second fixing block has an arc-shaped structure, and a diameter of a circle corresponding to the arc-shaped structure is greater than or equal to 20mm and less than or equal to 30mm.

15. The retractable data cable according to claim 1, wherein at least a portion of the housing is designed as a transparent area.

16. The retractable data cable according to claim 1, wherein the cable winding assembly further comprises a rebound assembly, the rebound assembly is disposed between the housing and the cable winding reel, one end of the rebound assembly is connected to the cable winding reel, and another end of the rebound assembly is connected to the housing.

17. The retractable data cable according to claim 16, wherein the second fixing block has an arc-shaped structure, and a diameter of a circle corresponding to the arc-shaped structure is greater than or equal to 3mm and less than or equal to 10mm.

18. The retractable data cable according to claim 1, wherein one of the cable winding reel and the housing is provided with an inner chute in annular shape and an outer chute in annular shape that are spaced apart, and another one of the cable winding reel and the housing is provided with a positioning member;
wherein an inlet and an outlet communicated with each other are formed between the inner chute and the outer chute, and a clamping groove is provided at the outlet; and
wherein the positioning member comprises a first seat portion and a positioning protrusion protruded from an end surface of the first seat portion, and the positioning protrusion is configured to be engaged in the clamping groove, to limit a rotation position of the cable winding reel relative to the housing.

19. The retractable data cable according to claim 18, wherein a first guide protrusion is provided at an inner sidewall of the inner chute, and the first guide protrusion is located at the outlet, to guide the positioning protrusion to slide into the clamping groove at the outlet, and
wherein a second guide protrusion is provided at an outer sidewall of the outer chute, and the second guide protrusion is located at the inlet, to guide the positioning protrusion to slide into the inner chute at the inlet.

20. The retractable data cable according to claim 1, wherein the retractable data cable further comprises a limit gear, a motion gear, a swing return member, and an auxiliary member;
wherein the motion gear is disposed on the cable winding reel, the swing return member and the limit gear are rotatably disposed on the housing, and the auxiliary member is disposed on the housing and has magnetic attraction with the swing return member;
wherein the motion gear is provided with a plurality of recesses, the swing return member is provided with a second cooperating element, and the second cooperating element can cooperate with the recesses;
wherein the swing return member is further provided with a pushing portion and a stopping portion that are protruding in an axial direction, and the limit gear is located between the pushing portion and the stopping portion;
in a case that the cable is pulled to extend, the cable winding reel and the motion gear rotate synchronously, the motion gear drives the swing return member to rotate to one side;
when the swing return member rotates, the pushing portion pushes the limit gear to rotate;
in a situation where a limit groove of the limit gear is pushed to a preset position, the second cooperating element provided on the swing return member slides out of one of the recesses of the motion gear, the auxiliary member cooperating with the swing return member provides a magnetic force for the swing return member, to allow the swing return member to rebound in an opposite side when no pulling force is provided for the cable, so that the swing return member cooperates with a next one of the recesses of the motion gear to realize position locking of the cable; and
in a situation where a return groove of the limit gear is pushed to a preset position, in a case that the cable is released, the swing return member swings back under the magnetic attraction of the auxiliary member, the stopping portion cooperates with the return groove, and the second cooperating element provided on the swing return member no longer cooperates with the recesses of the motion gear to complete retraction of the cable.
